(19) United States
(12) Patent Application Publication
(10) Pub. No.: US 2024/0320096 A1
(43) Pub. Date: Sep. 26, 2024

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Shunji TSUNASHIMA, Kanagawa (JP); Terutake Hayashi, Kanagawa (JP); Nobukazu Miyoshi, Kanagawa (JP); Ibuki KURODA, Kanagawa (JP)

(73) Assignee: FUJIFILM Business Innovation Corp., Tokyo (JP)

(21) Appl. No.: 18/455,648

(22) Filed: Aug. 25, 2023

(30) Foreign Application Priority Data
Mar. 24, 2023 (JP) 2023-048551

(51) Int. Cl. G06F 11/14; G06F 17/10

(52) U.S. Cl. CPC G06F 11/1402; G06F 17/10

(57) ABSTRACT

An information processing apparatus includes one or multiple processors configured to: when failing to acquire data, acquire division data in which the data is divided into parts with a division size; and repeat acquisition of the division data while increasing the division size stepwise.

### CROSS-REFERENCE TO RELATED APPLICATIONS

This application is based on and claims priority under 35 USC 119 from Japanese Patent Application No. 2023-048551 filed Mar. 24, 2023.

### BACKGROUND

### (i) Technical Field

The present disclosure relates to an information processing apparatus, a non-transitory computer readable medium, and an information processing method.

### (ii) Related Art

Japanese Unexamined Patent Application Publication No. 6-110824 discloses a bus bridge device. The bus bridge device is connected to a plurality of buses, and includes a relay unit that detects an access request over the plurality of buses, and relays the access request. In addition, the bus bridge device includes a retry unit that, upon initiation of access by the relay unit and reception of a response informing of an inappropriate data transfer size from an accessed device, changes the transfer size and retries access. In addition, the bus bridge device includes a transfer size change unit that refers to information on the result of a retry by the retry unit, and changes the transfer size at the time of access by the relay unit to conform to the accessed device.

Japanese Unexamined Patent Application Publication No. 2011-138576 discloses a data reproducing device that reads data using a data block consisting of multiple block codes as a unit. The data reproducing device includes an error detection correction circuit that decodes the block codes, a microprocessor that controls the data reproducing device, and a microcomputer interface used by the microprocessor to acquire a result of the error detection correction circuit. In addition, the data reproducing device includes a program memory that stores processing codes of the microprocessor, and a data memory that is readable and rewritable by the microprocessor. The program memory has a retry setting list including retry setting numbers, and retry parameters corresponding to the retry setting numbers. The data memory has a retry order table by which retry setting numbers are associated with an execution order, and a retry counter that counts the number of executions of retry reading for the same data block. When it is determined that proper data is not available based on the result of processing performed by the error detection correction circuit, the microprocessor executes retry reading. The microprocessor sets the retry parameters based on the retry counter, the retry order table, and the retry setting list, and executes retry reading.

### SUMMARY

When an information processing apparatus divides data failed to be acquired, and retries to acquire the data, it takes a longer time to acquire the data for a larger number of divisions of the data.

Aspects of non-limiting embodiments of the present disclosure relate to an information processing apparatus, a non-transitory computer readable medium, and an information processing method that are capable of reducing the time required for acquiring data, as compared to when data failed to be acquired is divided into parts with a minimum unit, and attempted to be acquired again.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

In order to achieve the above-mentioned object, according to a first aspect of the present disclosure, there is provided an information processing apparatus including one or a plurality of processors configured to: when failing to acquire data, acquire division data in which the data is divided into parts with a division size; and repeat acquisition of the division data while increasing the division size stepwise.

### BRIEF DESCRIPTION OF THE DRAWINGS

Exemplary embodiment of the present disclosure will be described in detail based on the following figures, wherein:

FIG. 1 is a schematic diagram illustrating an example of a hardware configuration of an information processing system according to an exemplary embodiment;

FIG. 2 is a block diagram illustrating an example of a hardware configuration of an information processing apparatus according to the exemplary embodiment;

FIG. 3 is a flowchart illustrating an example of a flow of information processing in an information processing apparatus according to a first exemplary embodiment;

FIG. 4 is a schematic chart illustrating an example of a configuration of a division size table according to the exemplary embodiment; and

FIG. 5 is a flowchart illustrating an example of a flow of information processing in an information processing apparatus according to a second exemplary embodiment.

### DETAILED DESCRIPTION

### First Exemplary Embodiment

Hereinafter, an example of an exemplary embodiment of the present disclosure will be described with reference to the drawings. Note that in each drawing, the same or equivalent components and portions are labeled with the same reference symbol. The dimensional ratio in the drawings is exaggerated for the sake of illustrative purposes, and may be different from the actual ratio.

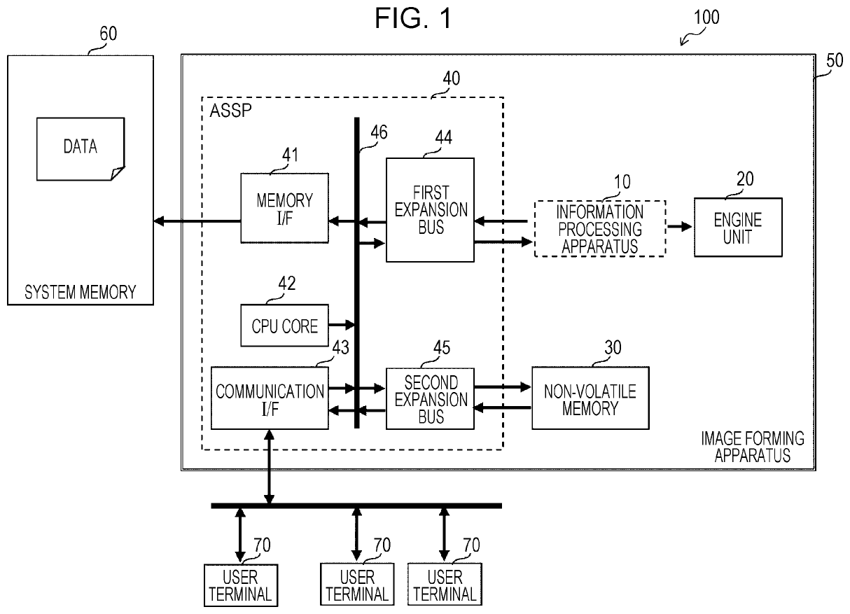

As illustrated in FIG. 1, an information processing system 100 according to the exemplary embodiment includes an image forming apparatus 50, a system memory 60, and user terminals 70. Note that the number of user terminals 70 is not limited to the number shown in FIG. 1.

The user terminals 70 and the image forming apparatus 50 can communicate with each other via a communication unit. Note that in the exemplary embodiment, a public communication line, such as the Internet or a phone line, is used as the communication unit. However, the communication unit is not limited to this example. For example, a communication line in a company, such as a local area network (LAN) or a wide area network (WAN), may be used as the communication unit, or alternatively, a communication line in a company and a public communication line may be used in combination. In the exemplary embodiment, a wireless communication line is used as the communication unit. However, as the communication unit, a wired communication line may be used or wired and wireless communication lines may be used in combination.

Each of the user terminals 70 is a terminal owned by a user who utilizes the image forming apparatus 50. For example, a personal computer, a tablet terminal, or a smartphone owned by a user may be used as the user terminal 70.

The system memory 60 is a volatile memory such as a dynamic random access memory (DRAM). The system memory 60 according to the exemplary embodiment stores data which is interpreted and generated from print data written in a page description language (PDL) and transmitted from the user terminal 70. However, the data is not limited to this example. The system memory 60 may store any data as long as the data is dividable.

The image forming apparatus 50 forms an image on a sheet of paper as a recording medium based on the data read from the system memory 60. The image forming apparatus 50 according to the exemplary embodiment includes an information processing apparatus 10, an engine unit 20, a non-volatile memory 30, and an application specific standard produce (ASSP) 40.

The engine unit 20 forms an image on a sheet of paper as a recording medium based on the image data generated from data acquired from the system memory 60 by the information processing apparatus 10.

The non-volatile memory 30 is an example of a storage device that maintains stored data even if supplied power is cut off, and is, for example, a semiconductor memory or a hard disk, such as a solid state drive (SSD). In the non-volatile memory 30 according to the exemplary embodiment, for example, Non-Volatile Memory Express (NVMe) is adopted.

The ASSP 40 has the components: a memory interface (I/F) 41, a central processing unit (CPU) core 42, a communication I/F 43, a first expansion bus 44, and a second expansion bus 45

The components are connected to each other via a bus 46 to enable mutual communication.

The memory I/F 41 is an interface to communicate with the system memory 60.

The CPU core 42 is a central processing unit, and executes various programs and controls the components.

The communication I/F 43 is an interface to communicate with the user terminals 70.

The first expansion bus 44 is an interface to communicate with the information processing apparatus 10. In the first expansion bus 44 according to the exemplary embodiment, for example, Peripheral Component Interconnect-Express (PCI-express) is adopted.

The second expansion bus 45 is an interface to communicate with the non-volatile memory 30. In the second expansion bus 45 according to the exemplary embodiment, for example, PCI-express is adopted.

The information processing apparatus 10 acquires data stored in the system memory 60 via the ASSP 40. The information processing apparatus 10 then generates image data based on the content written in the data. The information processing apparatus 10 then outputs the generated image data to the engine unit 20.

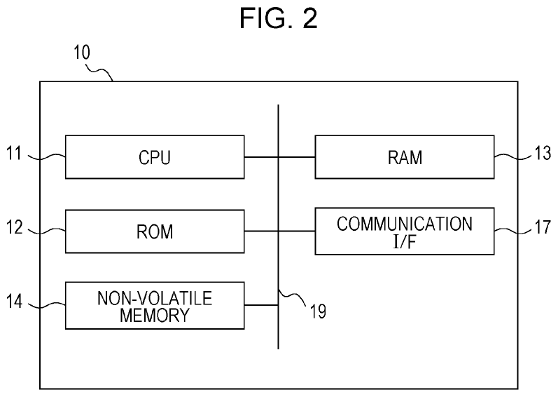

As illustrated in FIG. 2, the information processing apparatus 10 has the components: a CPU 11, a read only memory (ROM) 12, a random access memory (RAM) 13, a non-volatile memory 14, and a communication I/F 17. The components are connected to each other via a bus 19 to enable mutual communication.

The CPU 11 is a central processing unit, and executes various programs and controls the components. Specifically, the CPU 11 reads a program from the ROM 11 or the non-volatile memory 14, and executes the program using the RAM 13 as a work area. The CPU 11 performs control of the components and various arithmetic processes in accordance with the program recorded in the ROM 11. The non-volatile memory 14 is an example of a storage device that maintains stored data even if supplied power is cut off, and for example, a semiconductor memory or a hard disk, such as a solid state drive (SSD) may be used. In the exemplary embodiment, the non-volatile memory 14 stores information processing programs and a division size table.

The non-volatile memory 14 stores various programs and various data. The RAM 13 as a work area temporarily stores a program or data.

The communication I/F 17 is an interface to communicate with the ASSP 40 and the engine unit 20.

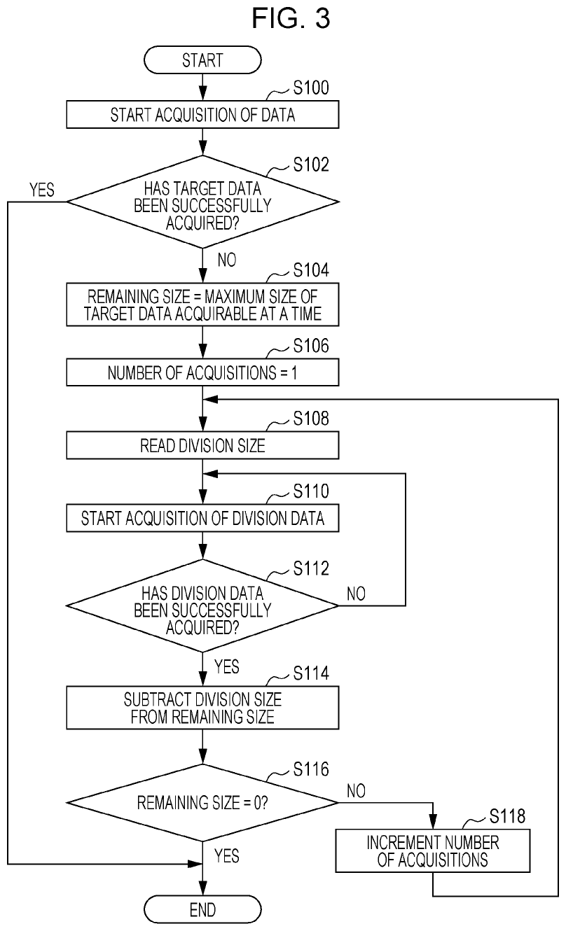

Next, the flow of information processing in the information processing apparatus 10 according to the exemplary embodiment will be described with reference to FIG. 3. The information processing is performed by the CPU 11 reading an information processing program from the non-volatile memory 14, and loading and executing the program in the RAM 13.

In step S100 of FIG. 3, the CPU 11 starts acquisition of data. Hereinafter, the data started to be acquired in step S100 is called target data.

In step S102, the CPU 11 determines whether the target data has been successfully acquired. When the target data has been successfully acquired (YES in step S102), the CPU 11 ends the information processing. In contrast, when the CPU 11 has failed to acquire the target data (NO in step S102), the flow proceeds to step S104.

In step S104, the CPU 11 defines a maximum size (hereinafter simply referred to as a “maximum size”) of target data acquirable at a time by the information processing apparatus 10 as the remaining size of remaining data not acquired yet among the target data.

In step S106, the CPU 11 sets the number of acquisitions to 1.

In step S108, the CPU 11 reads a division size associated with the set number of acquisitions from a division size table stored in the non-volatile memory 14.

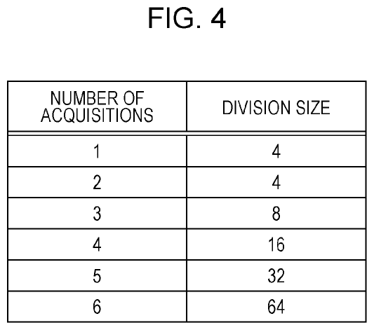

As illustrated in FIG. 4, the division size table stores the number of acquisitions and the division size in association with each other. In the division size table according to the exemplary embodiment, a division size is predefined so that the maximum size matches the total of division sizes, and the division size is greater for a larger number of acquisitions of the division data. In the division size table according to the exemplary embodiment, for each number of acquisitions, the division size is predefined to be a multiple of a minimum value (4 Bytes in the example illustrated in FIG. 4) of the division size. However, the division size is not limited to this example.

The example illustrated in FIG. 4 shows a division size table when the maximum size is 128 Bytes. Note that in the case where each division size is a multiple of the minimum value of the division size, when each division size is defined so that the division data is greater for a larger number of acquisitions, the maximum size may not match the total of division sizes. In this case, the division size may not be defined so that the division size is greater for a larger number of acquisitions. For example, as illustrated in FIG. 4, the division size associated with a certain number of acquisitions (when the number of acquisitions is 2 in the example illustrated in FIG. 4) may have the same value as the division size associated with a number of acquisitions smaller than the certain number.

In step S110, the CPU 11 starts acquisition of division data in which the target data is divided into parts with the division size read in step S108.

In step S112, the CPU 11 determines whether division data has been successfully acquired. When division data has been successfully acquired (YES in step S112), the flow proceeds to S114.

In contrast, when the CPU 11 fails to acquire division data (NO in step S112), the flow returns to S110. In other words, when failing to acquire division data, the CPU 11 performs a process of acquiring the division data again without changing the division size for the division data.

In step S114, the CPU 11 subtracts the division size read in step S108 from the remaining size set in step S104.

In step S116, the CPU 11 determines whether the remaining size is 0. When the remaining size is 0 (YES in step S116), the CPU 11 ends the information processing. In contrast, when the remaining size is greater than 0 (NO in step S116), the flow proceeds to step S118.

In step S118, the CPU 11 increments the number of acquisitions, and the flow returns to S108.

### Second Exemplary Embodiment

In the first exemplary embodiment, when failing to acquire division data, the CPU 11 performs a process of acquiring the division data again without changing the division size for the division data. In this exemplary embodiment, when failing to acquire division data, the CPU 11 changes the division size for the division data, and performs a process of acquiring the division data again. Hereinafter, the point of difference from the first exemplary embodiment will be described. Note that the hardware configuration is the same as that of the first exemplary embodiment, thus a description is omitted.

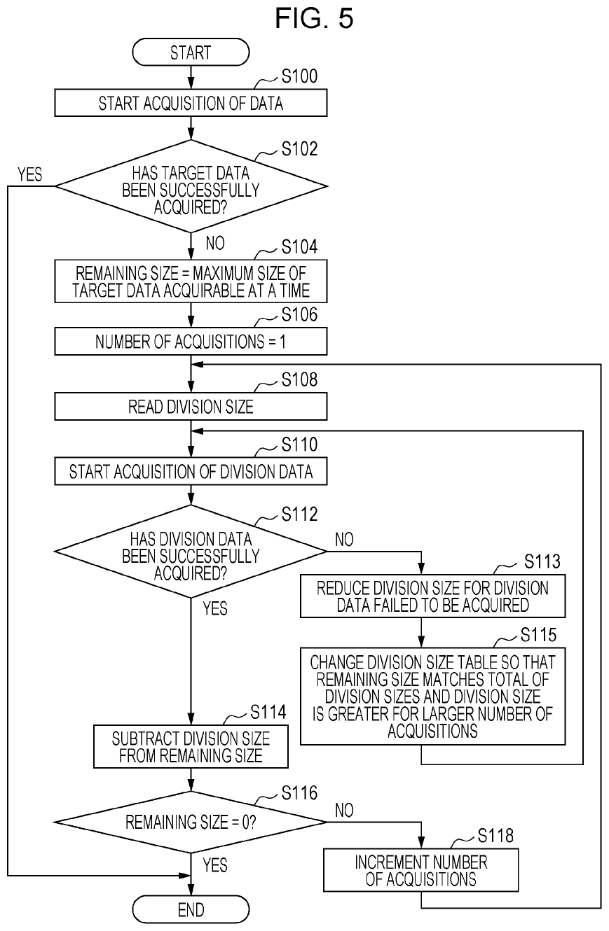

The flow of information processing in the information processing apparatus 10 of this exemplary embodiment will be described with reference to FIG. 5.

The flow of information processing illustrated in FIG. 5 differs from the first exemplary embodiment in that when negative determination is made in information processing step S112 illustrated in FIG. 3, the processes in step S113 and step S115 are performed, then the process in step S110 is performed.

In step S112 of FIG. 5, when acquisition of division data fails (NO in step S112), the flow proceeds to step S113.

In step S113, the CPU 11 changes the division size table to reduce the division size for the division data failed to be acquired. For example, in the division size table, the CPU 11 halves the division size for the division data failed to be acquired.

In step S115, the CPU 11 changes the division size table so that the remaining size matches the total of division sizes, and the division size is greater for a larger number of acquisitions. The CPU 11 returns to step S110.

For example, in the example illustrated in FIG. 4, when the number of acquisitions of the division data is four, the division size is 16 Bytes. In this case, when the CPU 11 has failed to acquire division data of 16 Bytes (NO in step S112), the CPU 11 changes the division size table to reduce the division size for the division data failed to be acquired. For example, in the division size table, the CPU 11 changes the division size from 16 Bytes to 8 Bytes for the fourth acquisition. The CPU 11 defines the division size for the fifth and sixth acquisitions so that the remaining size (112 Bytes which are scheduled to be acquired from the fourth to sixth acquisitions in the example illustrated in FIG. 4) matches the total of division sizes from the fourth to sixth acquisitions, and the division size is greater for a larger number of acquisitions.

Note that in this exemplary embodiment, when failing to acquire division data, the CPU 11 reduces the division size for the division data, and performs a process of acquiring the division data again. However, the configuration is not limited to this example. When failing to acquire division data, the CPU 11 may increase the division size for the division data, and perform a process of acquiring the division data again.

In this exemplary embodiment, when the division data is acquired with a size smaller than a predefined division size, the CPU 11 changes the predefined division size so that the remaining size matches the total of division sizes, and the division size is greater for a larger number of acquisitions. However, the configuration is not limited to this example. When the division data is acquired with a size larger than a predefined division size, the CPU 11 may change the predefined division size so that the remaining size matches the total of division sizes, and the division size is greater for a larger number of acquisitions.

Although the exemplary embodiments have been described above, the technical scope of the present disclosure is not limited to the scope described in the exemplary embodiments. In a range not departing from the spirit of the present disclosure, various modifications or improvements may be made to the exemplary embodiments, and modified or improved exemplary embodiments are also included in the technical scope of the present disclosure.

The exemplary embodiments above do not limit the disclosure according to the claims, and all combinations of the features described in the exemplary embodiments are not necessarily essential for the solution of the disclosure. The exemplary embodiments described above include novel concepts at various stages, and various concepts are extracted by combining a plurality of disclosed claim components. Even when some claim components are deleted from all the claim components shown in the exemplary embodiments, as long as the effect is obtained, the configuration with some claim components deleted can be extracted as a novel concept.

For example, in the exemplary embodiments above, the information processing apparatus 10 is included in the image forming apparatus 50. However, the configuration is not limited to this example. The information processing apparatus 10 may not be included in the image forming apparatus 50, as long as the information processing apparatus 10 acquires division data in which data is divided into parts with a division size, and repeats acquisition of the division data while increasing the division size stepwise.

In the exemplary embodiments above, the CPU 11 divides the data acquired from the system memory 60 provided outwardly of the information processing apparatus 10. However, the configuration is not limited to this example. The CPU 11 may divide the data acquired from a memory such as the non-volatile memory 14 provided inside the information processing apparatus 10. Alternatively, the CPU 11 may divide the data transmitted from the outside of the information processing apparatus 10.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiments above, a configuration has been described in which the programs are installed in the ROM, but the configuration is not limited to this. In the exemplary embodiments above, the CPU 21 has been described as a processor that reads and executes a control program stored in the memory 22 or the storage device 23, but is not limited thereto. The programs according to the exemplary embodiments above may be provided in a form of a computer readable recording medium on which the programs are recorded. For example, each of the programs according to the exemplary embodiments above may be provided in a form of an optical disk, such as a compact disc (CD)-ROM and a digital versatile disc (DVD)-ROM, on which the program is recorded, or a form of a semiconductor memory, such as a Universal Serial Bus (USB) memory and a memory card, on which the program is recorded. Alternatively, the program according to the exemplary embodiments above may be obtained from an external device via the communication IF 17.

In the exemplary embodiments above, a case has been described in which the process in the information processing apparatus 10 is implemented by a software configuration by executing a program using a computer; however, the present disclosure is not limited to this. For example, the process in the information processing apparatus 10 may be implemented by a hardware configuration, or a combination of a hardware configuration and a software configuration.

In addition, the configuration with the image forming apparatus 50, the system memory 60, and the user terminals 70 described in the exemplary embodiments above is an example, and it is needless to say that an unnecessary component may be deleted or a new component may be added in a range not departing from the spirit of the present disclosure.

The flow of processing (see FIGS. 3, 5) in the information processing apparatus 10 described in the exemplary embodiments above is also an example, and it is needless to say that an unnecessary step may be deleted, a new step may be added, or the order of processing may be changed in a range not departing from the spirit of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising:
one or a plurality of processors configured to:
   when failing to acquire data, acquire division data in which the data is divided into parts with a division size; and
   repeat acquisition of the division data while increasing the division size stepwise.
      (((2)))

The information processing apparatus according to (((1))),
wherein the processor is configured to:
   when failing to acquire the division data, perform a process of acquiring the division data again without changing the division size for the division data.
      (((3)))

The information processing apparatus according to (((1))),
wherein the processor is configured to, when failing to acquire the division data, change the division size for the division data, and perform a process of acquiring the division data again.
   (((4)))

The information processing apparatus according to (((3))),
wherein the processor is configured to, when failing to acquire the division data, reduce the division size for the division data, and perform a process of acquiring the division data again.
   (((5)))

The information processing apparatus according to any one of (((1))) to (((4))),
wherein the division size is predefined so that a maximum size of the data acquirable at a time matches a total of the division size, and the division size is greater for a larger number of acquisitions of the division data.
   (((6)))

The information processing apparatus according to (((5))),
wherein the processor is configured to:
   when the division data is acquired with a size different from the predefined division size, change the predefined division size so that a size of remaining data that is the data not acquired yet matches a total of the division size, and the division size is greater for a larger number of the acquisitions.
      (((7)))

An information processing program causing a computer to execute a process comprising:
when acquisition of data fails, acquiring division data in which the data is divided into parts with a division size; and
repeating acquisition of the division data while increasing the division size stepwise.

What is claimed is:

1. An information processing apparatus comprising:
one or a plurality of processors configured to:
when failing to acquire data, acquire division data in which the data is divided into parts with a division size; and
repeat acquisition of the division data while increasing the division size stepwise.

2. The information processing apparatus according to claim 1,
wherein the processor is configured to:
when failing to acquire the division data, perform a process of acquiring the division data again without changing the division size for the division data.

3. The information processing apparatus according to claim 1,
wherein the processor is configured to:
when failing to acquire the division data, change the division size for the division data, and perform a process of acquiring the division data again.

4. The information processing apparatus according to claim 3,
wherein the processor is configured to:
when failing to acquire the division data, reduce the division size for the division data, and perform a process of acquiring the division data again.

5. The information processing apparatus according to claim 1,
wherein the division size is predefined so that a maximum size of the data acquirable at a time matches a total of the division size, and the division size is greater for a larger number of acquisitions of the division data.

6. The information processing apparatus according to claim 5,
wherein the processor is configured to:
when the division data is acquired with a size different from the predefined division size, change the predefined division size so that a size of remaining data that is the data not acquired yet matches a total of the division size, and the division size is greater for a larger number of the acquisitions.

7. A non-transitory computer readable medium storing a program causing a computer to execute a process comprising:
when acquisition of data fails, acquiring division data in which the data is divided into parts with a division size; and
repeating acquisition of the division data while increasing the division size stepwise.

8. An information processing method comprising:
when acquisition of data fails, acquiring division data in which the data is divided into parts with a division size; and
repeating acquisition of the division data while increasing the division size stepwise.
